(19) United States
(12) Patent Application Publication
(10) Pub. No.: US 2009/0059298 A1
(43) Pub. Date: Mar. 5, 2009

(54) SIMULTANEOUS PRINTING OF PAGES FROM MULTIPLE JOBS

(76) Inventor: Geoffrey W. Huenemann, Vancouver (CA)

Correspondence Address: David A. Novais;Patent Legal Staff, Eastman Kodak Company, 343 State Street, Rochester, NY, 14650-2201, US

(21) Appl. No.: 11/849,534

(22) Filed: Sep. 4, 2007

(51) Int. Cl. G06F 15/00

(52) U.S. Cl. 358/1.18

(57) ABSTRACT

A workflow system (100) prints jobs (102) by producing a layout (106) of pages selected from job queue (103) and providing the layout (106) to a printing process (111). Efficient layouts (106) can be quickly produced by selecting pages based on layout criteria, ordering them according to a prioritization scheme and using a level packing scheme that includes iteratively increasing a fit tolerance for levels and pages.

### FIELD OF THE INVENTION

In the field of printing, multiple print jobs can be combined to reduce costs. In particular, jobs having pages of varying sizes can be combined to optimize use of production resources.

### BACKGROUND OF THE INVENTION

Various automated methods exist in the prior art for producing layouts from a selection of pages. Some methods are heuristic and optimize a cost function associated with the layout. These methods may take into consideration production attributes, such as required page quantity, preferred page orientation, preferred cutting arrangement, and the like. These methods tend to identify optimal layouts but require significant time and computing resources as they generally involve trying various permutations of page layout configurations until the cost function is optimized.

Some methods are algorithmic in nature, such as those disclosed in the paper titled “Recent advances on two-dimensional bin packing problems”, by Andrea Lodi et al, Discrete Applied Mathematics 123 (2002), pp. 379-396. In summary methods for packing bins of fixed width and infinite or finite height are disclosed. These methods are significantly faster than the heuristic methods and are typically on the order of N*logarithm (N) where N is the number of items to be packed. These methods involve creating levels within a bin and packing levels with items of decreasing height until all of the required items are placed. Some algorithms employ multiple phases that allow for increased level utilization. For example, large items can be packed on the floor of a level in the first phase and small items can be packed on the ceiling in the second phase, using the space remaining from the first phase. Some algorithms combine levels produced for an infinite height bin during a first phase into finite height bins in a second phase. The prior art algorithms are quick but do not take into consideration all of the job combining needs of a printing firm.

With the advent of online print procurement and increased pricing pressure, printing firms require job combining solutions that offer flexibility, speed, and efficiency. For example, an increased volume of varying short run length jobs is an expected trend. Capacity exhaustion on short-run printing presses may require that short run length jobs be combined or combined with longer run length jobs using other equipment in order to meet customer delivery expectations. As another example, it may be desirable to defer ganged print layout definition until as late as possible to allow for increased resource utilization and/or to accommodate rush jobs. However, just-in-time layouts must achieve a minimum level of cost efficiency or profitability to be useful. A printing firm may need to generate several alternate layouts based on varying criteria (e.g. layout size or press run length) so that a preferred combination of waiting print jobs can be determined.

### SUMMARY OF THE INVENTION

Briefly, according to one aspect of the present invention a method for printing a layout of pages comprises establishing criteria for producing the layout. Unplaced pages from a job queue are selected based on the layout criteria. An order for the unplaced pages is established based on the criteria. A layout is created from a subset of the unplaced pages based on the order and the criteria wherein creating includes: establishing a first tolerance; packing unplaced pages on levels of the layout based on the order and the tolerance; relaxing the tolerance; and repeating the packing step based on the relaxed tolerance.

The present invention provides a system and methods for automatically and rapidly producing efficient layouts of pages from multiple print jobs. Pages are selected based on criteria established for a layout and are ordered according to a prioritization scheme. In one embodiment a key factor in the prioritization scheme is time (e.g. job age or time until due).

The prioritized set of pages are then packed using an improved level packing scheme that includes iterations for increasing fit tolerance for levels and pages. This combination produces surprisingly efficient layouts at a rate that allows the system or an operator to explore various alternate layouts by adjusting layout criteria or job properties to find a layout that is efficient enough for use. Further the layouts are capable of being cut by simple cutting equipment, such as guillotine cutters.

According to one aspect of the invention, the efficiency of the layout generator enables a just-in-time layout production model for a printing firm having a significant number of combinable jobs. These and other aspects of the present invention are illustrated in the detailed description of the invention.

### BRIEF DESCRIPTION OF THE DRAWINGS

FIG. 1 is a block diagram of a printing workflow system according to the present invention.

FIG. 2 is a flow chart diagram of an exemplary method for printing according to the present invention.

FIG. 3 is a flow chart diagram of an exemplary method for creating a candidate layout according to the present invention.

FIG. 4 is a screenshot of an exemplary layout produced according to the present invention.

FIG. 5 depicts the layout of FIG. 4 in more detail.

### DETAILED DESCRIPTION OF THE INVENTION

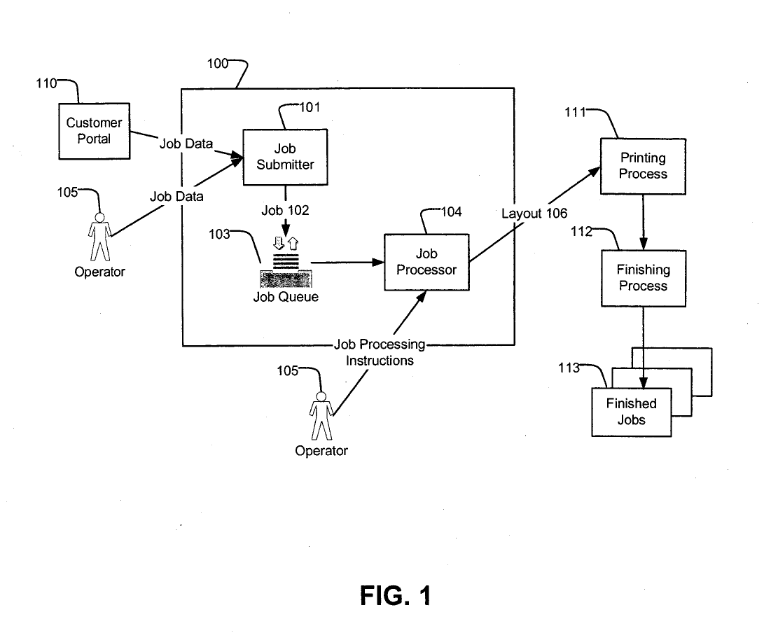

FIG. 1 is a block diagram of a printing workflow system 100 according to the present invention. Workflow system 100 includes job submitter 101 for creating new print jobs. New print jobs 102 are created from job data submitted by an operator 105 or from an external system such as a customer portal 1 10. Jobs can include one or more pages with intent including attributes describing at least quantity, quality and urgency. For the purposes of this application, a page is printable content having some geometry. Jobs 102 can be placed in a job queue 103 for processing by job processor 104. Job processor 104 can include various prepress functions such as pre-flight, color matching, trapping, layout, rendering, proofing, plate-making and the like. Operator 105 can control the operation of job processor 104 by providing job processing instructions and obtaining job processing information. Job processor 104 can operate in fully automatic mode, based on instructions, and can allow operator 105 to control them interactively as well.

A rendering of layout 106 is produced for a printing process 111. As previously described, it can be advantageous to combine pages from more than one job 102 into a layout 106. Layout 106 can take many forms. For example, layout 106 can comprise data describing how pages are to be arranged. As another example, layout 106 can comprise digital image data representing the arrangement of pages, suitable for process by a digital printing press. As another example, layout 106 can comprise printing film or plates exposed with information based on the arrangement of pages. As another example, layout 106 can comprise selected pages from various jobs 102 to be displayed together on a proofing media. As another example, layout 106 can comprise pages from various jobs 102 to be printed together using relatively expensive printing media such as flexographic plates.

Printing process 111 reproduces one or more copies of layout 106 which are then finished by finishing process 112 to result in finished jobs 113 that are ready for delivery. A finished job includes a number of page reproductions as specified by job 102 and cut from one or more layouts 106. Other finishing processes such as folding and binding may be required to accomplish intent specified by job 102.

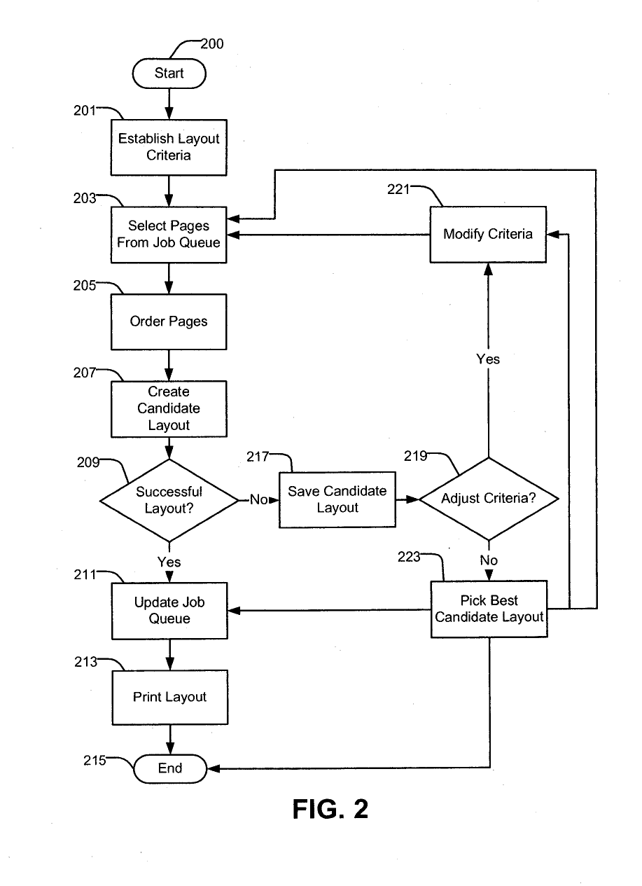

FIG. 2 is a flow chart diagram of an exemplary method for printing according to the present invention. The method begins at block 200 where it is assumed that a number of jobs 102 have been submitted to job queue 103. For clarity, the method focuses on layout aspects and describes creation of a single layout 106 based on a static job queue 103. It is understood that new jobs 102 may be submitted to job queue 103 dynamically and that the method can be repeated continuously or on a periodic basis to produce a stream of layouts from job queue 103.

Proceeding at block 201, workflow system 100 or operator 105 establishes criteria for layout 106. This can involve dynamically establishing criteria, perhaps by evaluating job queue 103 to identify a range of criteria applicable to the current job queue (e.g. 30 jobs are due within two days, or 60 jobs require a certain printing condition). Alternatively, this can involve establishing pre-determined criteria for various printing conditions that are common or desirable for the printing firm. For example, criteria may be established for various types and/or sizes of printing stock. In addition, criteria may be established for various types or instances of printing devices (e.g. stock type and size, inking capabilities, optimal run length range, and quality measure). Criteria can be specified as parameter name value pairs or as logical expressions or as rules or the like.

In some embodiments, where pre-defined criteria are established, various candidate layouts 106 can be computed based on different criteria to determine which candidate layout 106 is optimal. For example, in a just-in-time production environment, critical resource schedules can be used to determine one or more candidate layout criteria.

In some embodiments, it may be desirable to specify secondary parameter values for criteria. For example, one parameter of the criteria may specify that layout 106 only include pages intended to print on high quality white paper stock. A secondary parameter value can establish that pages intended to print on lower quality white paper stock can be included if a more efficient layout 106 can be realized. One skilled in the art will realize that ranges of parameter values and other schemes can be established to identify secondary criteria including a hierarchy of preferences for one or groups of parameters.

Run length is another potentially important parameter in the layout criteria. In particular, the minimum quantity of each page to be included in layout 106 can be derived from page quantity information in job 102 and the intended printing run length. The range of possible run lengths may be large or may be constrained by the printing firm's business rules. For example, print job quantities may be restricted to be multiples of some quanta (e.g. 100) or may be restricted based on the type of page (e.g. business card), or may be restricted based on the type of printing device normally selected for that type of work (e.g. minimum quantity for jobs intended for a particular printing press to justify make-ready).

Once the criteria have been established, the method proceeds to block 203 where at least some of the criteria are used to select pages from job queue 103 for inclusion in layout 106. For example, assume the criteria established a 32 inch×44 inch size, a high quality white paper stock with a gloss coating, standard four color inks, and a run length of 250 for layout 106. This may be appropriate, for example, if this is the current configuration of the next printing press scheduled to become available. Workflow system 100 selects pages from jobs 102 in job queue 103 that have not yet been incorporated in other layouts 106. The number of pages to be considered is based on the run length. For example, if job 102 specifies a page quantity of 1000, four copies of that page will be considered for layout 106 since the intended run length is 250.

Experiments have shown the present invention produces reasonably efficient layouts 106 when the number of pages to place is above a certain threshold. Efficiency reduces dramatically as the number of queued pages is reduced below the threshold. One strategy that can be used to combat this situation is to adjust the run length to increase the page count. Criteria can include parameters for determining how to apply this strategy. For example, one value may indicate that a specified run length is paramount. Another exemplary parameter value may indicate that run length modification should only be considered after first producing a candidate layout 106 with the preferred run length. Another exemplary parameter value may indicate that exceeding the page count threshold is paramount.

Assuming a suitable set of pages, the method proceeds next to block 205 where the pages are ordered based on a prioritization scheme. In one preferred embodiment the scheme is based on time. For example, the age of a job 102 in job queue 103 can be used to give pages from older jobs an earlier position in the order. As another example, due date can be used to give pages due sooner an earlier position in the order. In more complex schemes, age and due date can be combined in a weighted fashion. Additionally, other factors such as customer loyalty, profit margin for a job and other prioritization factors can help influence a page's position in the order. As another example, it may be advantageous to shift the order of one or more pages to improve the efficiency of layout 106 or to promote inclusion/exclusion of a selected page.

In some embodiments, aspects considered in the prioritization scheme can be used to establish the criteria. For example, at block 201, the prioritization scheme can be used to identify the next most important page in the job queue and identify layout criteria that match that page (e.g. paper stock for the page and layout size and run length for an available press).

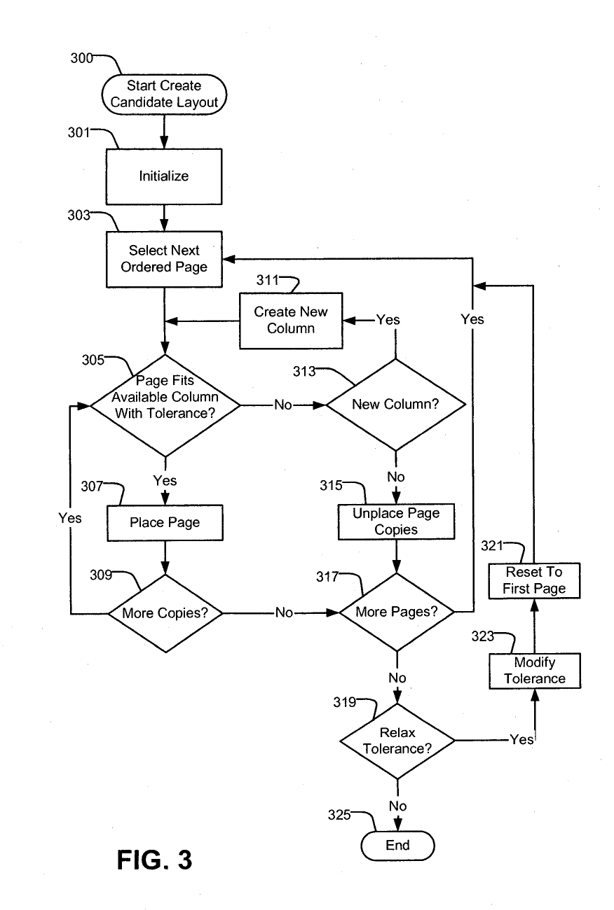

Proceeding from block 205 to block 207, the method creates a candidate layout. Details of this block are described below for FIG. 3. Next, at block 209, the method determines whether the candidate layout 106 was successful. For example, one criterion for a successful layout 106 can be a minimum efficiency. As another example, if the earliest due date associated with a page in candidate layout 106 is within a pre-determined time (e.g. lead time for printing and finishing) the candidate layout 106 can deemed successful. Other success criteria, including manual approval, can be established and/or combined to judge candidate layout 106.

If candidate layout 106 is deemed successful at block 209, the method proceeds to block 211 where jobs 102 in job queue 103 are updated based on pages that have been successfully placed in layout 106. If all pages have been placed, then job 102 may be removed from queue 103 or its status may be changed so that its pages are no longer eligible for future layouts 106. If only some pages have been placed, then the job is updated so that only the remaining pages are eligible for future layouts 106.

Proceeding at block 213, successful layout 106 is either provided to printing process 111 or is further processed (e.g. rendering) by job processor 104 before printing, perhaps asynchronously at a later time. The method then proceeds to block 215 where the method ends having printed or scheduled printing of one successful layout 106.

If candidate layout 106 is deemed unsuccessful at block 209, the methods proceeds to block 217 where, in some embodiments, the candidate layout 106 is saved for consideration later in the method in case no better candidate layout can be identified. The method then proceeds to block 219 where it determines whether any criteria can be adjusted (e.g. secondary parameter values as described above). If one or more parameters can still be adjusted, the method proceeds to block 221 where they are modified. The method retains a history of modifications so that consideration of secondary criteria is limited. The method then proceeds to block 203 where the set of pages is re-selected. This may result in a better solution if new eligible pages have been added to the queue or if existing pages are now eligible.

If block 219 determines that no more adjustments can be made to the layout criteria, the method proceeds to block 223 where the best candidate layout is selected and the method proceeds to block 211. This can be an automatic step or can involve operator 105 evaluating the candidate layouts 106 and associated information (e.g. layout preview, pages included from page selection, jobs affected by layout, layout efficiency, and modified criteria). If none of the candidates is adequate, operator 105 may be able to determine new criteria modifications to consider and proceed to block 221. In addition, he may reset criteria information and adjust job properties (e.g. change job properties affecting page selection or ordering) and proceed to block 203 to effectively restart the method with a different selection and/or ordering of pages. Additionally, operator 105 may decide to abandon the method for the current layout criteria and proceed to block 215.

FIG. 3 is a flow chart diagram of an exemplary method for creating a candidate layout 106, corresponding to block 207, according to the present invention. The method begins at block 300 and proceeds to block 301 where method data is initialized. In particular, a tolerance value is set to an initial value and the current page is identified as the first page of the ordered set of pages. In addition, level information and placed page information is cleared. For the purposes of this application, a level is a subset of the area of layout 106. In one preferred embodiment, a level corresponds to a column of layout 106 having a defined height and width. For clarity, the term column will be used in the remainder of the discussion, but it is understood that a row or other subset of the area of layout 106 can be a level.

In one preferred embodiment, tolerance is specified as a percentage value and can be used to determine whether a page fits within a column width. For example, a zero tolerance means the page width (or height) must equal the column width. Tolerance can also be used to determine whether the creation of a column of a particular size is allowed for the layout 106 (e.g. is the area width remaining after adding a column less than the tolerance). In one preferred embodiment, the initial tolerance value is zero.

The method proceeds after initialization to block 303 where the next page of the order is selected (e.g. first page initially). Next the method proceeds to block 305 where it is determined if the current page fits an available column with the current tolerance. Initially, since no levels exist, the method proceeds to block 313 to determine if a new column can be added based on the current page. On the other hand, if one or more columns exists and the page has a dimension that is equal to or less than the width (within tolerance) of one of the columns and an orthogonal page dimension is less than or equal to the remaining height of the selected column, the page is deemed to fit that column within tolerance and the method proceeds to block 307. When multiple columns are available, they can each be examined for a fit.

Proceeding at block 313 the method determines whether a new column can be created from the remaining area of layout 106. In addition to the tolerance condition described above, the method can allow a column to be added if the remaining area width is greater than some dimension. In one preferred embodiment, the remaining area must be more than half the width of a previously added column (e.g. last column or widest column). If a new column can be created, the method proceeds to block 311. Otherwise, the method proceeds to block 315.

Proceeding at block 311, the method creates new column information corresponding to an area of layout 106. In a preferred embodiment, columns are created starting at one side of the area of layout 106 and are created adjacent the last created column. Other new column placement schemes can be envisioned (e.g. start in the center and grow in the direction where the most space exists). Column width can be established based on one of the dimensions of the current page (e.g. allowing the page to be rotated). In some embodiments, layout criteria can specify whether to respect a preferred orientation, specified for a page, when creating a column and/or placing a page.

In some embodiments, each applicable dimension of the current page can be used as the basis for the new column. One or more columns can be configured to be eligible for this testing, with each choice potentially producing a completely different candidate layout solution. This iteration can be incorporated within the method of FIG. 3 (not shown) or incorporated as part of the multiple candidate generation capabilities of FIG. 2 (e.g. blocks 217-221). As another alternative, iterations for this or other multiple candidate scenarios can be configured to be time-limited (e.g. at block 219).

After creating a new column, the method returns to block 305 to again test whether the current page fits any available column within tolerance, which it now will.

Proceeding from block 305 to block 307 the method places the current page in the selected column. It updates column information indicating remaining height and it updates page information indicating that the current page from the order has been placed.

According to one preferred embodiment of the invention, the method then proceeds to block 309 to determine if additional copies of the current page from the same job (e.g. likely next in the order) need to be placed. This is done to ensure that the required quantity of a page is produced by layout 106. In some embodiments, this aspect can be controlled by the layout criteria. If additional copies of the page exist in the order, then the method proceeds back to block 305 to attempt to fit each of them as the new current page. Otherwise, the method proceeds to block 317.

At block 315, in some embodiments of the invention, any placed page copies are removed from layout 106 if any required copies of the page cannot be placed. This ensures that pages for job 102 are not split across layouts. In other embodiments, or through configured criteria, this block can be omitted.

Proceeding at block 317, the method determines if more pages exist in the ordered set of pages. If yes, the method proceeds to block 303 to select the next page in the order. Otherwise, the method determines that a current packing iteration has completed and it proceeds to block 319 to determine if iteration with a relaxed tolerance is required. If iteration is not required, the method proceeds to block 325 and ends. Otherwise, the method proceeds to block 323 to modify the tolerance.

In one preferred embodiment tolerance is relaxed to a nominal value and then relaxed fully. When fully relaxed, a page can fit in a column if its width is less than or equal to the column width. Similarly, a column of any width that fits in the remaining area can be created. Experiments with random sized pages indicated that efficiency was maximized with a nominal tolerance value in the range of 8 to 15%. The optimal value varied, depending on the number of pages selected and the degree of similarity amongst the pages. The method of FIG. 3, as shown, takes on the order of N Logarithim (N) time to run where N is the number of pages in the ordered set of pages. Thus, system 100 can be configured to learn what tolerance values are best for certain mixes of page sizes. A preferred tolerance value or set of values can be used to generate candidate layouts 106 based on the learned data. Alternatively, tolerance values can be established as part of the layout criteria and be subject to modification.

In some embodiments, iterations can also be performed based on placement of multiple copies of a page at a time instead of a single page. For example, a first iteration for a tolerance value attempts to place single pages while a second iteration for the same tolerance value attempts to place two or more copies of a page that has more than one copy in the ordered set of pages. Multiple small pages may thus be able to fill smaller spaces left in columns that other larger pages are not eligible to fill.

Proceeding from block 323 to block 321, the method resets the current page pointer to the first unplaced page from the ordered set of pages and then proceeds to block 303 to iterate with the modified tolerance.

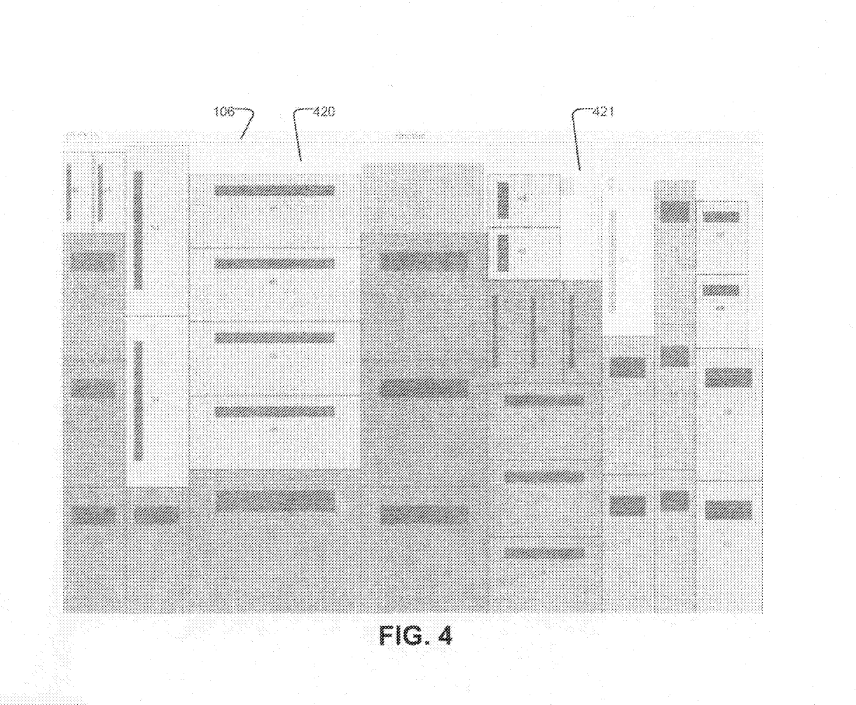

FIG. 4 is a screenshot of an exemplary layout 106 produced according to the present invention. Layout 106 was produced using a prototype embodiment of the present invention and can be used to illustrate a number of aspects of the method. Layout 106 includes placed pages, illustrated as rectangles of various colors and shades with a page number, representing the page's position in the ordered set of pages. Unused area 420 indicates portions of layout 106 that are not occupied by placed pages. Portions of unused area 421 show parts of pages that were tentatively placed and then removed according to the method. These pages appear in the background without their position number visible.

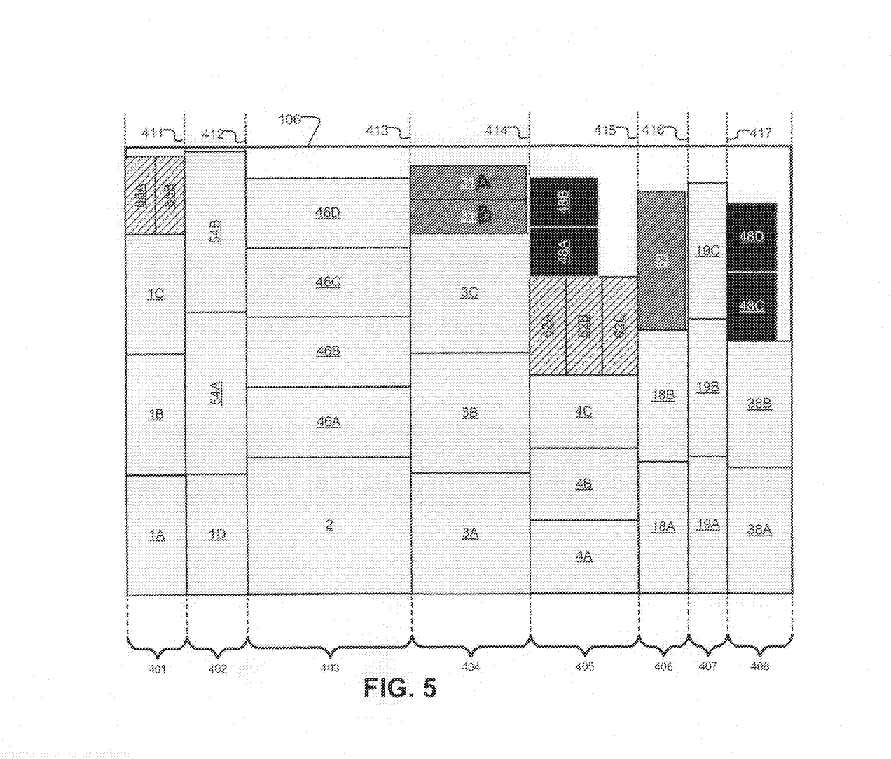

FIG. 5 depicts the layout 106 of FIG. 4 in more detail and will be used for a detailed example of the method. In particular, only permanently placed pages are illustrated. Each placed page depicts an underlined reference number indicating the page position (or alternatively page identifier) in the ordered set of selected pages. The orientation of each reference numeral indicates the orientation of the placed page (e.g. normal or rotated). For example, pages 1A-1D correspond to four copies of a page from job 102 and correspond to the first four positions in the ordered set of pages. Columns 401-408, established during creation of layout 106 are also illustrated and correspond with lines 411-417 which indicate where guillotine cuts can made in finishing process 112.

Pages are depicted with different fill patterns. A light grey pattern, such as used for page 2, indicates that the page was placed during the initial tolerance iteration. A medium grey pattern, such as used for pages 31A, 31B, and 69, indicates that the page was placed during a nominal tolerance iteration. A dark grey pattern, such as used for pages 48A-48D, indicates that the page was placed during a fully relaxed tolerance iteration. A hashed pattern, such as for pages 62A-62C, 85A, and 85B, indicates a page placed during an iteration where multiple copies of pages are eligible for placement at a time.

The creation of layout 106 of FIG. 5 will now be described with respect to the method of FIG. 3. Table 1, see below, illustrates an ordered set of pages that was input to the method of FIG. 3. The Page number column depicts the reference numeral of the page as shown in FIG. 5, but without the alpha suffix corresponding to the copy. Width and Height columns depict the dimensions of the page in some units. The number of copies value for each page was randomly generated as were the page dimensions, that latter generated with a granularity of 5 units. Note that the area of intended layout 106 for this example is 1200 units (wide)×800 units (high). The values for placed pages are emboldened.

The method of FIG. 3 begins by creating first column 401 for page 1 and places three copies 1A-1C in column 401. Since the fourth copy 1D does not fit, a new column 402 is created. Next, page 2 is considered but does not fit available columns within the initial tolerance and causes creation of column 403. Next, pages 3A-3C are considered, but they do not fit within the initial tolerance so column 404 is created and all three copies 3A-3C are placed there. Next pages 4A-4C are considered, but they also do not fit an existing column exactly so column 405 is created and all three copies 4A-4C are placed there. Next, page 5 (not shown) is considered, but it does not fit an existing column, nor can a new column be created that either completely fills the remaining width of layout 106 or leaves the required amount of free width for layout 106. The method proceeds with considering pages 6-17 without placement until it encounters page 18, which has a sufficiently narrow dimension to enable creation of a new column 406. Both copies 18A and 18B are placed in column 406. The method proceeds similarly, placing pages 19A-19C in column 407. Then no pages fit until pages 38A and 38B, having a dimension that is exactly the remaining width of layout 106 resulting in creation of column 408. Pages 46A-46D and 54A-54B are the last pages of the order than can be fit in available columns with zero tolerance in the first iteration.

In the second iteration, the method of FIG. 3 attempts to fit multiple copies of pages into available columns, starting at the beginning of the order, with initial tolerance, and considering any remaining unplaced pages. The method finds that three rotated copies of pages 62A-62C can fit in the remaining space of column 405. Similarly, the method finds that two rotated copies of page 85 can fit in the remaining space of column 401.

TABLE 1

| Page | No. Of | | |
|---|---|---|---|
| No. | Copies | Width | Height |
| 1 | 4 | 110 | 215 |
| 2 | 1 | 295 | 245 |
| 3 | 3 | 215 | 215 |
| 4 | 3 | 195 | 130 |
| 5 | 2 | 255 | 215 |
| 6 | 3 | 235 | 245 |
| 7 | 1 | 350 | 210 |
| 8 | 2 | 145 | 145 |
| 9 | 2 | 215 | 210 |
| 10 | 2 | 250 | 250 |
| 11 | 5 | 265 | 195 |
| 12 | 2 | 170 | 255 |
| 13 | 2 | 335 | 185 |
| 14 | 2 | 220 | 160 |
| 15 | 2 | 230 | 140 |
| 16 | 3 | 260 | 225 |
| 17 | 2 | 300 | 180 |
| 18 | 2 | 90 | 235 |
| 19 | 3 | 70 | 245 |
| 20 | 1 | 235 | 235 |
| 21 | 2 | 170 | 300 |
| 22 | 2 | 190 | 180 |
| 23 | 3 | 150 | 310 |
| 24 | 6 | 70 | 180 |
| 25 | 2 | 290 | 105 |
| 26 | 4 | 335 | 235 |
| 27 | 3 | 335 | 130 |
| 28 | 3 | 345 | 245 |
| 29 | 4 | 220 | 135 |
| 30 | 3 | 205 | 235 |
| 31 | 2 | 60 | 210 |
| 32 | 2 | 270 | 175 |
| 33 | 3 | 170 | 350 |
| 34 | 4 | 315 | 200 |
| 35 | 2 | 135 | 145 |
| 36 | 3 | 120 | 230 |
| 37 | 3 | 270 | 140 |
| 38 | 2 | 115 | 225 |
| 39 | 2 | 130 | 160 |
| 40 | 1 | 245 | 230 |
| 41 | 3 | 150 | 230 |
| 42 | 2 | 330 | 140 |
| 43 | 5 | 320 | 75 |
| 44 | 3 | 205 | 175 |
| 45 | 5 | 310 | 65 |
| 46 | 4 | 295 | 125 |
| 47 | 2 | 100 | 285 |
| 48 | 4 | 90 | 125 |
| 49 | 6 | 155 | 225 |
| 50 | 3 | 120 | 130 |
| 51 | 3 | 245 | 240 |
| 52 | 4 | 235 | 140 |
| 53 | 2 | 295 | 180 |
| 54 | 2 | 290 | 110 |
| 55 | 4 | 275 | 115 |
| 56 | 1 | 165 | 225 |
| 57 | 2 | 315 | 200 |
| 58 | 2 | 215 | 235 |
| 59 | 5 | 90 | 180 |
| 60 | 4 | 280 | 195 |
| 61 | 4 | 320 | 195 |
| 62 | 3 | 175 | 65 |
| 63 | 2 | 260 | 180 |
| 64 | 4 | 115 | 140 |
| 65 | 2 | 295 | 235 |
| 66 | 1 | 275 | 185 |
| 67 | 1 | 290 | 150 |
| 68 | 4 | 305 | 185 |
| 69 | 1 | 250 | 85 |
| 70 | 5 | 260 | 105 |
| 71 | 4 | 285 | 245 |
| 72 | 5 | 230 | 180 |
| 73 | 2 | 275 | 110 |
| 74 | 1 | 125 | 135 |
| 75 | 2 | 300 | 95 |
| 76 | 2 | 310 | 165 |
| 77 | 1 | 270 | 230 |
| 78 | 3 | 105 | 135 |
| 79 | 2 | 85 | 165 |
| 80 | 4 | 200 | 215 |
| 81 | 1 | 290 | 165 |
| 82 | 3 | 325 | 215 |
| 83 | 3 | 315 | 150 |
| 84 | 1 | 130 | 65 |
| 85 | 2 | 140 | 55 |

In the third iteration, the method of FIG. 3 relaxes the tolerance to a nominal value. In this case, the nominal value selected was 15%. Single page placement is considered in this iteration. Page 31 is the first page the method finds that can fit an available column with 15% tolerance. Both copies 31A and 31B fit in column 404. Page 69 also fits within tolerance for column 406 when rotated. No other pages are found to fit for this iteration or a subsequent iteration modified to require multiple pages to be placed at a time (fourth iteration).

In the fifth iteration, the method of FIG. 3 relaxes the tolerance fully. For this single page placement iteration two copies of pages 48A and 48B can be fit rotated in column 405 while the other two copies of page 48, 48C and 48D, can be fit in column 408. No other pages can be fit for this or the sixth iteration which requires multiple page placements.

The efficiency of example layout 106 in FIG. 5 is approximately 91%. Fifty trials using the prototype embodiment averaged 94.3% efficiency with efficiencies ranging from 89% to 98%. The prototype tool could produce approximately 60 layouts per second using one CPU of a 2.33 GHz Intel Core 2 Duo Macintosh computer using a queue of approximately 200 randomly sized pages. For shorter queues, similar results could be achieved by altering run length so that more page copies would be required and thus still achieve an approximate page queue length of 200 pages. It is clear that creating layouts at such a rate allows for exploration of optimal solutions dictated by secondary parameter values of the layout criteria without creating significant delays in layout creation.

Iterating on page orientations for new columns can reduce performance significantly unless the number of eligible levels is restricted. The duration for the method of FIG. 3 with iterative page orientations was found to take on the order of four seconds per page with the same computer configuration but improved the efficiency (e.g. lower bound of 92% instead of 89%).

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1A page copy
1B page copy
1C page copy
1D page copy
2 page
3A page copy
3B page copy
3C page copy
4A page copy
4B page copy
4C page copy
18A page copy
18B page copy
19A page copy
19B page copy
19C page copy
31A page copy
31B page copy
38A page copy
38B page copy
46A page copy
46B page copy
46C page copy
46D page copy
48A page copy
48B page copy
48C page copy
48D page copy
54A page copy
54B page copy
62A page copy
62B page copy
62C page copy
69 page
85A page copy
85B page copy
100 workflow system
101 job submitter
102 job
103 job queue
104 job processor
105 operator
106 layout
110 customer portal
111 printing process
112 finishing process
113 finished result
200 method block
201 method block
203 method block
205 method block
207 method block
209 method block
211 method block
213 method block
215 method block
217 method block
219 method block
221 method block
223 method block
300 method block
301 method block
303 method block
305 method block
307 method block
309 method block
311 method block
313 method block
315 method block
317 method block
319 method block
321 method block
323 method block
325 method block
401 column
402 column
403 column
404 column
405 column
406 column
407 column
408 column
411 line
412 line
413 line
414 line
415 line
416 line
417 line
420 unused area
421 unused area

1. A method for printing a layout of pages, the method comprising:
establishing criteria for producing the layout;
selecting unplaced pages from a job queue based on the layout criteria;
establishing an order for the unplaced pages based on the criteria; and
creating a layout from a subset of the unplaced pages based on the order and the criteria wherein creating includes:
establishing a first tolerance;
packing unplaced pages on levels of the layout based on the order and the tolerance;
relaxing the tolerance; and
repeating the packing step based on the relaxed tolerance.

2. A method according to claim 1 wherein the layout is provided to a printing process for printing and the printed layout is provided to a finishing process for finishing.

3. A method according to claim 2 wherein pages of the layout can be separated by cutting equipment capable of making a single cut at a time.

4. A method according to claim 2 wherein the criteria for producing the layout is established based on the schedule of a critical resource associated with the printing process or the finishing process.

5. A method according to claim 1 wherein creating a layout includes creating a candidate layout.

6. A method according to claim 5 including identifying the candidate layout as the desired layout wherein pages cover more than a predetermined percentage of the layout area.

7. A method according to claim 5 including:
saving a candidate layout wherein pages cover less than a predetermined percentage of the layout area;
modifying at least one of the criteria for producing the layout and the job properties associated with the unplaced pages;
generating another candidate layout; and
selecting the best candidate layout from amongst the set of candidate layouts produced.

8. A method according to claim 1 wherein selecting unplaced pages includes checking to ensure that the number of unplaced pages selected is above a threshold value chosen based on layout efficiency.

9. A method according to claim 8 including:
modifying at least one of the criteria for producing the layout and the job properties associated with jobs in the job queue to increase the number of unplaced pages; and
reselecting unplaced pages based on the modification.

10. A method according to claim 1 wherein establishing criteria for producing the layout includes establishing secondary criteria for generating secondary layout candidates.

11. A method according to claim 1 wherein packing unplaced pages on levels of the layout based on the order and the tolerance comprises:
(a) selecting a current page based on the order;
(b) placing the current page on an existing level if it fits within the tolerance;
(c) creating a new level based on a dimension of the current page otherwise wherein the layout dimension remaining is greater than a predetermined amount or less than the tolerance; and
(d) determining a next current page based on the order and the result of step (c) and repeating steps (b) and (c) until all pages in the ordered set of pages have been considered.

12. A method according to claim 11 including:
(e) selecting the first unplaced page based on the order; and
(f) repeating steps (b) to (d) but requiring that multiple copies of the current page be placed adjacently at one time in an available level.

13. A method according to claim 11 wherein creating the new level based on the dimension of the current page comprises iteratively creating different new levels where each new level corresponds to different dimensions of the current page and wherein each iteration is associated with a plurality of potentially different candidate layouts.

14. A method according to claim 13 wherein iteratively creating different new levels is limited based on one or more of a time limit for iterations or a number of levels eligible for iteration.
